(19) United States
(12) Patent Application Publication
(10) Pub. No.: US 2025/0109321 A1
(43) Pub. Date: Apr. 3, 2025

(54) METHOD OF PREPARATION AND APPLICATION OF POLYURETHANE ADHESIVE

(71) Applicant: Honeywell Federal Manufacturing & Technologies, LLC, Kansas City, MO (US)

(72) Inventors: Hallie Buyle, Kansas City, MO (US); Connor Daniel Pearson, Kansas City, MO (US)

(21) Appl. No.: 18/477,679

(22) Filed: Sep. 29, 2023

(51) Int. Cl. C09J 7/35; C09J 5/06; C09J 7/10; C09J 7/40

(52) U.S. Cl. CPC C09J 7/35; C09J 5/06; C09J 7/10; C09J 7/405; C09J 2301/304; C09J 2427/005; C09J 2475/00

(57) ABSTRACT

A method for preparing and applying a polyurethane adhesive comprises: mixing a part A component and a part B component of a polyurethane compound; pouring the polyurethane compound onto a first non-stick film positioned on a planar mold; placing a second non-stick film on an upper surface of the polyurethane compound; applying a pressure to the first non-stick film and/or the second non-stick film to give the polyurethane compound a specified thickness; allowing the polyurethane compound to solidify for a first period of time to form a non-tack polyurethane adhesive; cutting the polyurethane adhesive and the two non-stick films according to a size of the mating surfaces of the two objects to be joined together; placing the cut polyurethane adhesive in contact with one of the mating surfaces and hold the other mating surface in contact with the polyurethane adhesive; and heating and applying pressure to the cut polyurethane adhesive.

### FEDERALLY SPONSORED RESEARCH AND DEVELOPMENT

This invention was made with Government support under Contract No.: DE-NA0002839 awarded by the United States Department of Energy/National Nuclear Security Administration. The Government has certain rights in the invention.

### FIELD OF THE INVENTION

Embodiments of the current invention relate to methods of preparing and applying a polyurethane adhesive.

### BACKGROUND OF THE INVENTION

Polyurethane adhesives are typically produced in a liquid form that is applied to the surfaces of two or more objects that are to be bonded together. Drawbacks to liquid polyurethane adhesives are that they are difficult to apply to the objects because they tend to run or drip and may stray onto surfaces other than the bonding surfaces, resulting in unnecessary efforts to remove the adhesive from non-bonding surfaces.

### SUMMARY OF THE INVENTION

Embodiments of the current invention address one or more of the above-mentioned problems and provide a distinct advance in the art of preparing and applying a polyurethane adhesive by forming an adhesive that is solid which makes it easier to handle and reduces the possibility of the adhesive straying on to non-bonding surfaces. A method for preparing and applying the polyurethane adhesive comprises: mixing a part A component and a part B component of a polyurethane compound; pouring the polyurethane compound onto a first non-stick film positioned on a planar mold; placing a second non-stick film on an upper surface of the polyurethane compound; applying a pressure to the first non-stick film and/or the second non-stick film to give the polyurethane compound a specified thickness; allowing the polyurethane compound to solidify for a first period of time to form a non-tack polyurethane adhesive sheet; cutting the polyurethane adhesive sheet and the two non-stick films according to a size of the mating surfaces of the two objects to be joined together; removing the two non-stick films from the polyurethane adhesive sheet; placing the cut polyurethane adhesive in contact with one of the mating surfaces and applying pressure to hold the other mating surface in contact with the polyurethane adhesive; and heating the cut polyurethane adhesive.

Another method for preparing and applying a polyurethane adhesive comprises: mixing an isocyanate and an amine curing agent of a polyurethane compound; pouring the polyurethane compound onto a first non-stick film positioned on a planar mold; placing a second non-stick film on an upper surface of the polyurethane compound; applying a pressure to the first non-stick film and/or the second non-stick film to give the polyurethane compound a thickness ranging from approximately 0.004 inches to approximately 0.040 inches; allowing the polyurethane compound to solidify at room temperature for a first period of time to form a non-tack polyurethane adhesive sheet; cutting the polyurethane adhesive sheet and the two non-stick films according to a size of the mating surfaces of the two objects to be joined together; removing the two non-stick films from the polyurethane adhesive sheet; placing the cut polyurethane adhesive in contact with one of the mating surfaces and applying pressure to hold the other mating surface in contact with the polyurethane adhesive; and heating the cut polyurethane adhesive to a curing temperature.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a listing of at least a portion of the steps of a method for preparing and applying a polyurethane adhesive;

FIG. 2 is an upper perspective view of a mold retaining a first non-stick film and a polyurethane compound, wherein a second non-stick film is configured to be applied to an upper surface of the polyurethane compound;

FIG. 3 is an upper perspective view of the first non-stick film and the second non-stick film after a period of time when the polyurethane compound has solidified into the polyurethane adhesive;

FIG. 4 is a listing of at least a portion of the steps of another method for preparing and applying a polyurethane adhesive;

FIG. 5 is a side elevational view of a pair of pinch rollers receiving a polyurethane adhesive, a first non-stick film, and a second non-stick film; and

FIG. 6 is a side elevational view of the pinch rollers receiving the polyurethane adhesive and a second non-stick film only.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

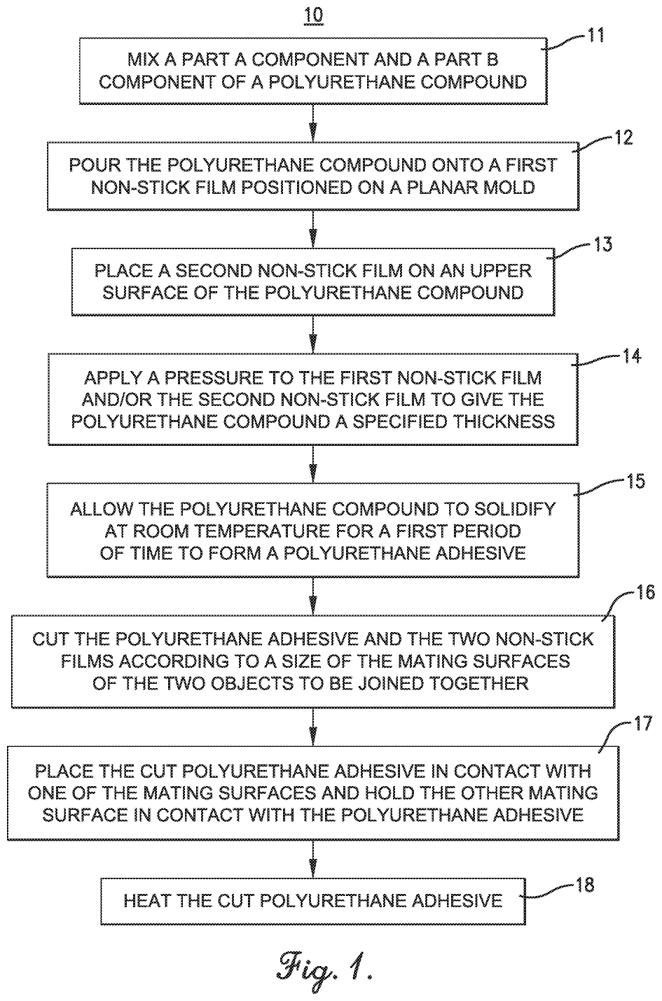

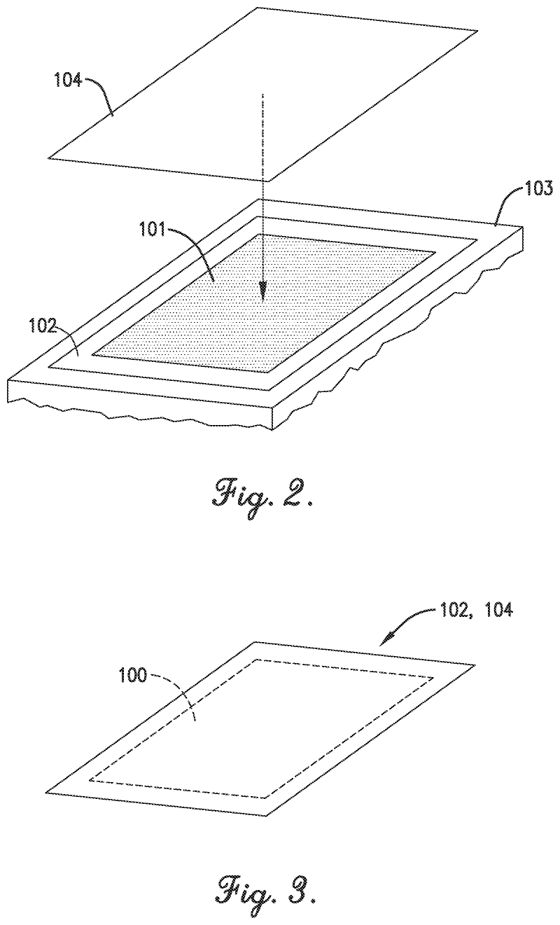

At least a portion of the steps of a method 10, presented in accordance with various embodiments of the current invention, for a preparation and application of a polyurethane adhesive 100 is shown in FIG. 1. The method 10 is utilized to prepare a polyurethane adhesive 100 for use in bonding two objects together. The polyurethane adhesive 100 is solid during application, making the adhesive 100 easier to handle and reducing the possibility of the adhesive 100 straying on to non-bonding surfaces.

Variations to the steps may be performed. The steps may be performed in the order shown in FIG. 1, or they may be performed in a different order. Furthermore, some steps may be performed concurrently as opposed to sequentially. In addition, some steps may be optional or may not be performed.

Referring to step 11, a part A component and a part B component are mixed to form a polyurethane compound 101. The part A component may include a prepolymer including an isocyanate, and the part B component may include an amine curing agent. Each component exists in liquid form and is poured into a container in which the two components are stirred, mixed, and/or blended either by machine or by hand until the polyurethane compound 101 is homogenous.

Referring to step 12, the polyurethane compound 101 is poured onto a first non-stick film 102 that is positioned on a planar mold 103. The first non-stick film 102 may include non-stick coatings or constituents, such as polytetrafluoroethylene (PTFE). The mold 103 typically has a flat surface that is larger than the desired surface area of the polyurethane adhesive 100. In some embodiments, the mold 103 may have a lip or upward flange along its perimeter to stop the flow of liquid. In addition, the mold 103 itself may have a non-stick coating, such as PTFE, on its surface. In other embodiments, the mold 103 may have a non-planar surface and may include contours or angled features that extend below the plane and/or above the plane.

Referring to step 13, a second non-stick film 104 is placed on an upper surface of the polyurethane compound 101. The second non-stick film 104 may include non-stick coatings or constituents, such as PTFE.

Referring to step 14, a pressure is applied to the first non-stick film 102, the second non-stick film 104, or both non-stick films 102, 104. The pressure is normal to the upper surface (through the second non-stick film 104) and/or the lower surface (through the first non-stick film 102) of the polyurethane compound 101. In various embodiments, the first non-stick film 102, the polyurethane compound 101, and the second non-stick film 104 are placed in a machine press, which applies the pressure to the first non-stick film 102, the second non-stick film 104, or both non-stick films 102, 104. The pressure is applied, as described, in order to give the polyurethane compound 101 a specified thickness or a specific shape. A mold or shims may be used to ensure a known thickness of the pressed adhesive sheet. In some embodiments, the pressure is applied to give the polyurethane compound 101 a thickness ranging from approximately 0.004 inches to approximately 0.040 inches.

Referring to step 15, the polyurethane compound 101 is allowed to solidify at room temperature for a first period of time to form the polyurethane adhesive 100. The first period of time is approximately twenty-four (24) hours. In other embodiments, the first non-stick film 102, the polyurethane compound 101, the second non-stick film 104, and optionally, the machine press, are placed in a controlled temperature and atmosphere chamber so that the polyurethane compound 101 is allowed to solidify at colder than room temperature and lower humidity to remove moisture from the polyurethane compound 101. In various embodiments, the first non-stick film 102, the polyurethane compound 101, and the second non-stick film 104 may be allowed to solidify at a temperature ranging from greater than 32 degrees F. to approximately 75 degrees F. After the first period of time, the polyurethane adhesive 100 is in the form of a sheet that is not tacky or sticky. The polyurethane adhesive 100 is still covered by the first non-stick film 102 and the second non-stick film 104.

Referring to step 16, the polyurethane adhesive 100 and the two non-stick films 102, 104 are cut to size according to a size of the mating surfaces of the two objects to bonded to one another. For example, if the mating surfaces of the two objects to be bonded to one another have dimensions of two (2) inches by one (1) inch, then the polyurethane adhesive 100 and the two non-stick films 102, 104 are cut to have dimensions of two (2) inches by one (1) inch.

Referring to step 17, the cut polyurethane adhesive 100 is removed from the two non-stick films 102, 104 and placed in contact with one of the mating surfaces. The other mating surface is placed in contact with the cut polyurethane adhesive 100 and held in place.

Referring to step 18, the cut polyurethane adhesive 100, at least, is heated to a curing temperature. The combination of the two objects and the cut polyurethane adhesive 100 may be placed in a heating chamber, such as an oven, a kiln, or the like. Or, a heating device may be used to provide heat directly to the joint or bonding area. The polyurethane adhesive 100 may require a second period of time to cure. In exemplary embodiments, the combination of the two objects and the cut polyurethane adhesive 100 are heated at a temperature of approximately 250 degrees Fahrenheit (F) and with a pressure of approximately 50 pounds per square inch (psi). The second period of time, for curing the cut polyurethane adhesive 100, is greater than or equal to one hour.

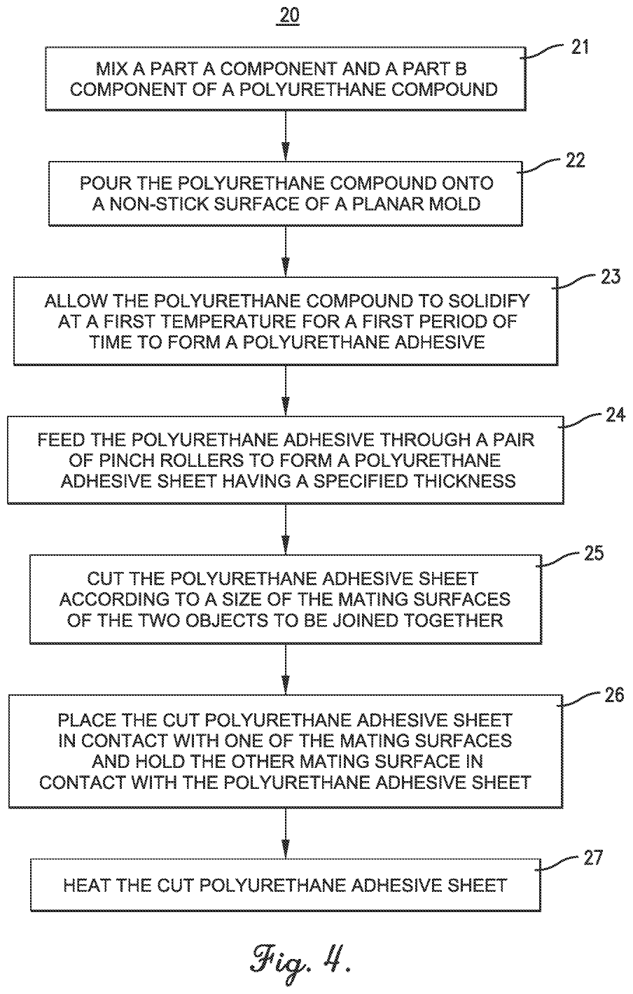

At least a portion of the steps of a method 20, presented in accordance with other embodiments of the current invention, for a preparation and application of a polyurethane adhesive 100 is shown in FIG. 4. Variations to the steps may be performed. The steps may be performed in the order shown in FIG. 4, or they may be performed in a different order. Furthermore, some steps may be performed concurrently as opposed to sequentially. In addition, some steps may be optional or may not be performed.

Referring to step 21, a part A component and a part B component are mixed to form a polyurethane compound 101. Each component exists in liquid form and is poured into a container in which the two components are stirred, mixed, and/or blended either by machine or by hand until the polyurethane compound 101 is homogenous.

Referring to step 22, the polyurethane compound 101 is poured onto a non-stick surface of the planar mold 103. The non-stick surface may be the surface of the mold 103 itself, or the non-stick surface may be a non-stick film, such as the film 102.

Referring to step 23, the polyurethane compound 101 is allowed to solidify at a first temperature for a first period of time to form the polyurethane adhesive 100. The first period of time is approximately twenty-four (24) hours. The first temperature may range from greater than 32 degrees F. to approximately 75 degrees F. After the first period of time, the polyurethane adhesive 100 is in a form that is not tacky or sticky. The polyurethane adhesive 100 may be in a sheet form with a variable or non-uniform thickness.

Referring to step 24, the polyurethane adhesive 100 is fed through a pair of pinch rollers 110 to form a polyurethane adhesive sheet 105. The pinch rollers 110 each include a circumferential outer surface with a gap, or space, between the two outer surfaces. The size of the gap is selectively controlled to have a value ranging from approximately 0.004 inches to approximately 0.040 inches. The pinch rollers 110 are rotated, by machine or by hand, to force the polyurethane adhesive 100 through the gap.

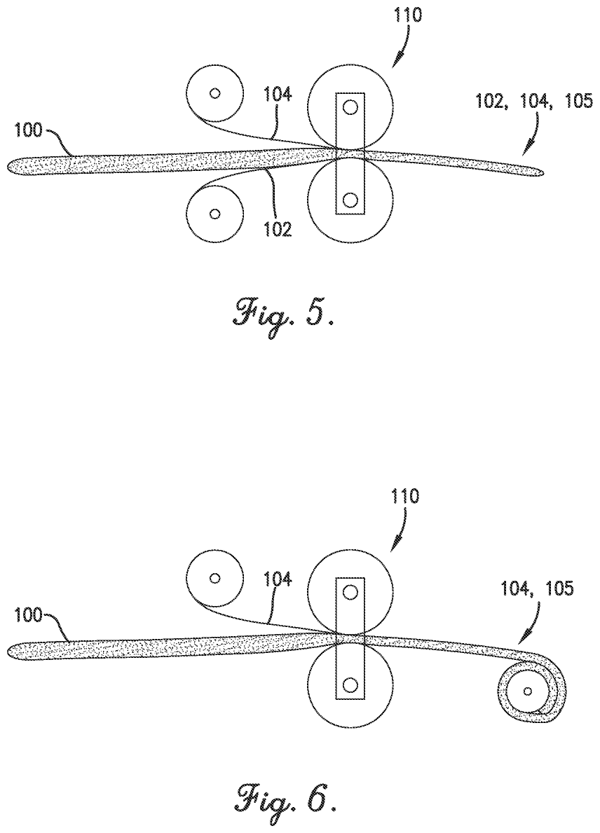

In some embodiments as shown in FIG. 5, the first non-stick film 102 may be streamed from a roller beneath the polyurethane adhesive 100 and fed into the pinch rollers 110 to contact a lower surface of the polyurethane adhesive 100. And, the second non-stick film 104 may be streamed from a roller above the polyurethane adhesive 100 and fed into the pinch rollers 110 to contact an upper surface of the polyurethane adhesive 100. Thus, the polyurethane adhesive sheet 105 may include the first non-stick film 102 on its lower surface and the second non-stick film 104 on its upper surface.

In other embodiments as shown in FIG. 6, only the second non-stick film 104 may be streamed from a roller above the polyurethane adhesive 100 and fed into the pinch rollers 110 to contact an upper surface of the polyurethane adhesive 100. The polyurethane adhesive sheet 105 and the second non-stick film 104 output from the pinch rollers 110 may then be spooled onto another roll.

As an alternative, cold lamination machinery and techniques may be utilized to form the polyurethane adhesive sheet 105.

Referring to step 25, the polyurethane adhesive sheet 105 is cut to size according to a size of the mating surfaces of the two objects to bonded to one another. For example, if the mating surfaces of the two objects to be bonded to one another have dimensions of two (2) inches by one (1) inch, then the polyurethane adhesive 100 is cut to have dimensions of two (2) inches by one (1) inch. Either the second non-stick film 104 or both non-stick films 102, 104 are cut to the same dimensions as well.

Referring to step 26, the cut polyurethane adhesive sheet 105 is removed from the one or two non-stick films 102, 104 and placed in contact with one of the mating surfaces. The other mating surface is placed in contact with the cut polyurethane adhesive sheet 105 and held in place.

Referring to step 27, the cut polyurethane adhesive sheet 105, at least, is heated to a curing temperature. The combination of the two objects and the cut polyurethane adhesive sheet 105 may be placed in a heating chamber, such as an oven, a kiln, or the like. Or, a heating device may be used to provide heat directly to the joint or bonding area. The polyurethane adhesive sheet 105 may require a second period of time to cure. In exemplary embodiments, the combination of the two objects and the cut polyurethane adhesive sheet 105 are heated at a temperature of approximately 250 degrees Fahrenheit (F) and with a pressure of approximately 50 pounds per square inch (psi). The second period of time, for curing the cut polyurethane adhesive sheet 105, is greater than or equal to one hour.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A method for preparing and applying a polyurethane adhesive, the method comprising:
mixing a part A component and a part B component of a polyurethane compound;
pouring the polyurethane compound onto a first non-stick film positioned on a planar mold;
placing a second non-stick film on an upper surface of the polyurethane compound;
applying a pressure to the first non-stick film and/or the second non-stick film to give the polyurethane compound a specified thickness;
allowing the polyurethane compound to solidify for a first period of time to form a polyurethane adhesive;
cutting the polyurethane adhesive and the two non-stick films according to a size of the mating surfaces of the two objects to be joined together;
placing the cut polyurethane adhesive in contact with one of the mating surfaces and hold the other mating surface in contact with the polyurethane adhesive; and
heating the cut polyurethane adhesive.

2. The method of claim 1, wherein the part A component includes a prepolymer including an isocyanate.

3. The method of claim 1, wherein the part B component includes an amine curing agent.

4. The method of claim 1, wherein the polyurethane compound is allowed to solidify at a temperature ranging from greater than 32 degrees F. to approximately 75 degrees.

5. The method of claim 1, wherein the polyurethane compound is pressed to have a thickness of ranging from approximately 0.004 inches to approximately 0.040 inches.

6. The method of claim 1, wherein each of the first non-stick film and the second non-stick film includes polytetrafluoroethylene.

7. The method of claim 1, wherein the cut polyurethane adhesive is heated to a curing temperature.

8. A method for preparing and applying a polyurethane adhesive, the method comprising:
mixing an isocyanate and an amine curing agent of a polyurethane compound;
pouring the polyurethane compound onto a first non-stick film positioned on a planar mold;
placing a second non-stick film on an upper surface of the polyurethane compound;
applying a pressure to the first non-stick film and/or the second non-stick film to give the polyurethane compound a thickness of approximately 0.005 inches;
allowing the polyurethane compound to solidify at room temperature for a first period of time to form a polyurethane adhesive;
cutting the polyurethane adhesive and the two non-stick films according to a size of the mating surfaces of the two objects to be joined together;
placing the cut polyurethane adhesive in contact with one of the mating surfaces and hold the other mating surface in contact with the polyurethane adhesive; and
heating the cut polyurethane adhesive to a curing temperature.

9. A method for preparing and applying a polyurethane adhesive, the method comprising:
mixing a part A component and a part B component of a polyurethane compound;
pouring the polyurethane compound onto a non-stick surface of a planar mold;
allowing the polyurethane compound to solidify for a first period of time to form a polyurethane adhesive;
feeding the polyurethane adhesive through a pair of pinch rollers to form a polyurethane adhesive sheet having a specified thickness;
cutting the polyurethane adhesive sheet according to a size of the mating surfaces of the two objects to be joined together;
placing the cut polyurethane adhesive sheet in contact with one of the mating surfaces and hold the other mating surface in contact with the polyurethane adhesive sheet; and
heating the cut polyurethane adhesive sheet.

10. The method of claim 9, wherein the part A component includes a prepolymer including an isocyanate.

11. The method of claim 9, wherein the part B component includes an amine curing agent.

12. The method of claim 9, wherein the polyurethane compound is allowed to solidify at a temperature ranging from greater than 32 degrees F. to approximately 75 degrees.

13. The method of claim 9, wherein the polyurethane compound is pressed to have a thickness of ranging from approximately 0.004 inches to approximately 0.040 inches.

14. The method of claim 9, wherein the cut polyurethane adhesive is heated to a curing temperature.
